(19) United States
(12) Patent Application Publication
(10) Pub. No.: US 2026/0296800 A1
(43) Pub. Date: Oct. 1, 2026

(54) Device for Transporting and Needs-Based Buffering of Containers

(71) Applicant: Krones AG, Neutraubling (DE)

(72) Inventors: Ahmad ALSHEIKH, Neutraubling (DE); Thomas BACHHUBER, Kirchdorf (DE)

(21) Appl. No.: 19/633,028

(22) Filed: Mar. 30, 2026

(30) Foreign Application Priority Data
Apr. 1, 2025 (DE) 102025112655.0

(51) Int. Cl. B65G 47/64; B65G 43/08; B65G 47/68; B67C 7/00

(52) U.S. Cl. CPC B65G 47/64; B65G 43/08; B65G 2047/685; B65G 2201/0244; B65G 2201/0252; B65G 2203/0241; B65G 2811/095; B67C 7/0006

(57) ABSTRACT

A device for transporting and needs-based buffering of containers includes an inlet, a distribution region, a buffer region, an outlet, and a control unit. Containers can be transported along a first direction at the inlet. The distribution region has at least two transport belts movable independently of each other in a second direction opposite to the first direction. Containers fed from the distribution region to the buffer region can be conveyed and buffered independently of each other in a third direction transverse to the second direction in at least two buffer tracks. Containers can be fed from the buffer region to the outlet, where they can be conveyed along a fourth direction parallel to the third direction. The control unit controls the device such that that containers are fed, according to an order in the inlet, to the outlet in substantially the same order after passing through the buffer region.

### CROSS-REFERENCE TO RELATED APPLICATIONS

This application claims priority to, and the benefit of, German Patent Application No. 102025112655.0, filed Apr. 1, 2025, the contents of which are incorporated by reference herein in their entirety.

### TECHNICAL FIELD

The present invention relates to a device for transporting and needs-based buffering of containers and to a method for transporting and needs-based buffering of containers.

### BACKGROUND

Devices for transporting and buffering containers are known in principle from the prior art.

For example, WO 2024/008342 A1 shows an apparatus for automatically setting a container transport system on a plurality of regions that together form a mass transport system. The individual transport belts and regions can be controlled in such a way that the most even distribution possible across the entire width of the conveyors is possible.

However, when buffering containers, there is a fundamental problem that the devices are usually very large and can react to changes in process parameters upstream and downstream of the corresponding buffers only to a limited extent, so that flexible setting of the buffer capacity is either difficult or the space requirement of the buffers becomes large.

### BRIEF SUMMARY

One aspect of the invention relates to a device for transporting and needs-based buffering of containers, with which the buffering can be efficiently ensured in the case of changing operating parameters and at the same time saves as much space as possible.

The device according to the invention for transporting and needs-based buffering of containers comprises an inlet in which containers can be transported along a first direction, a distribution region comprising at least two transport belts movable independently of each other in a second direction opposite to the first direction, wherein the containers can be fed from the inlet to the distribution region, a buffer region to which containers can be fed from the distribution region, wherein the containers in the buffer region can be conveyed and buffered independently of each other in a third direction transverse to the second direction in at least two buffer tracks, an outlet to which containers can be fed from the buffer region and in which containers can be conveyed along a fourth direction parallel to the third direction, wherein the device comprises a control unit configured to control the at least two transport belts and the at least two buffer tracks such that containers are fed, according to an order in the inlet, to the outlet in substantially the same order after passing through the buffer region.

The inlet can be either an ordered inlet or in the form of a mass conveyor and can include one or more transport belts in which the containers can be transported. At least in one region, where the containers pass into the distribution region, the inlet is preferably configured in such a way that the containers can distribute themselves arbitrarily in the inlet and in the distribution region.

The buffer tracks can each be configured to comprise exactly one transport belt. Alternatively, however, it is also possible that each buffer track includes at least two or more transport belts, wherein these transport belts are then preferably all moved at the same speed, or containers in this respective buffer track and the corresponding transport belts of the buffer track always have the same speed. Preferably, no separation takes place between the individual buffer tracks in the buffer region, so that containers can pass between the buffer tracks. However, this is not necessarily the case, and it may also be provided that at least partial limitations such as baffles are arranged in the buffer region, which limitations extend in the third direction over at least part of the buffer tracks and thus prevent containers from passing from a first buffer track into an adjacent buffer track.

The control unit can be configured in particular as a computer with associated memory and processor, wherein program instructions can be stored in the memory which, when executed by the processor, enable control of the transport belts and the buffer tracks.

Controlling the transport belts and buffer tracks can be understood within the meaning of the invention as meaning that the control unit can control drive devices such as motors, in particular servomotors, which are assigned to the respective transport belts and buffer regions, and can thereby set a transport speed of the containers and/or an acceleration of the containers and/or a deceleration of the containers in the respective transport belts or buffer tracks.

According to the invention, the fact that the containers are fed, in accordance with an order at the inlet, to the outlet in substantially the same order after passing through the buffer zone, is to be understood as meaning that the transport of the containers by the device from the inlet to the outlet preferably takes place according to a first-in-first-out principle, so that a container that enters the distribution region from the inlet first also passes from the buffer zone into the outlet first.

However, due to the potentially incompletely ordered transport of containers in the buffer region, and in particular during the transition from the distribution region into the buffer region and from the buffer region to the outlet, it is possible that containers may pass into the outlet at a slightly different location than in the original order in the inlet.

According to the invention, it is therefore also included that the substantially same order also includes a minor reorientation or rearrangement of the order of the containers, such that even a minor change in the order of the containers or in the arrangement of the containers by a maximum absolute amount, for example by ±5 places or around ±10 places or around ±20 places or around ±50 places is possible. Alternatively, a relative value, for example depending on the maximum buffer capacity, can also specify the limit up to which an order in the outlet still substantially corresponds to the order in the inlet. For example, it may be provided here that a deviation of the container's place from the original order by up to 0.1% of the total buffer capacity measured in containers, or by up to 0.2%, or up to 0.5%, or up to 1%, is still understood according to the invention as being substantially the same order as in the inlet.

This device allows for flexible transport of the containers through the buffer device when buffering is not required, without changing the arrangement of the containers in the process. At the same time, by controlling the buffer tracks, the buffer capacity can be increased as needed, while still maintaining the order of the containers. This enables efficient and at the same time flexible transport of containers within the device.

It may be provided that the control unit is designed to control the at least two transport belts and/or the at least two buffer tracks depending on a necessary buffer capacity.

Compared to simply passing containers through the buffer region or transport belts, for example reducing the transport speed of the containers in one of the buffer tracks can cause the containers to also pass into an adjacent buffer track, thus causing buffering of the containers in the buffer region. This can be selected precisely in such a way that a necessary buffer capacity is ensured by the buffer region and at the same time the containers reach the outlet in substantially the same order as they were fed into the inlet. This further increases the flexibility of the device as required, when buffering containers.

In one embodiment, it is provided that the device includes a detector for detecting a container throughput at the inlet and/or at the outlet, and that the control unit is configured to determine a necessary buffer capacity based on the detected container throughput.

The detector can be, for example, a camera, light barrier or the like, and can be provided in the inlet and/or outlet, in order to determine a container throughput in the inlet and/or outlet. Based on this, it can then be determined whether the container throughput is greater in the inlet than in the outlet, or, if the detector is for example provided only in one of the two, whether it exceeds a predefined limit. Depending on whether this limit is exceeded, or depending on the difference in container throughput at the inlet and outlet, the necessary buffer capacity can then be determined and the transport belts and/or the at least two buffer tracks can be controlled depending on the required buffer capacity. This allows for a targeted response to changing circumstances, such as upstream or downstream of the device, by adjusting the buffer capacity.

It may be provided that the control unit is configured to determine the necessary buffer capacity based on at least one operating parameter that is indicative of a container inflow and/or container outflow from the device. The operating parameter may, for example, be or include a throughput of a container treatment machine (defining the container inflow) arranged upstream of the device, and/or a throughput of containers in a container treatment machine downstream of the device (defining the container outflow). Depending on any difference in these throughputs and/or depending on whether the throughput(s) upstream or downstream of the device exceed or fall below a predetermined limit, the necessary buffer capacity can then be adjusted.

It may be provided that controlling the at least two transport belts and/or the at least two buffer tracks includes controlling a transport speed and/or controlling an acceleration of containers in the at least two transport belts and/or the at least two buffer tracks. By adjusting transport speeds or accelerations, which should also include decelerations of the containers, it is possible to react flexibly to any changes in the overall container transport in order to thus adjust the buffer capacity.

The inlet and/or outlet may include a multi-row container conveyor. The multi-row container conveyors can in particular be configured as individual transport belts arranged parallel to each other, in which the containers can be transported in a single row. The transport belts can be at least partially separated from one another by separating elements such as baffles, so that the transport of the containers in the respective transport belts is carried out in an ordered manner. This makes it possible to reliably distribute the containers subsequently, for example over several container treatment machines.

The device may include a deflection element for deflecting containers from the inlet to the distribution region, and/or the device may include a guide element that tapers the buffer region towards the outlet and can guide containers in the buffer region towards the outlet.

The deflection element can, for example, be configured as a curved baffle, in order to allow the containers to transfer from the inlet to the distribution region. The containers are conveyed against the deflection element in the inlet and, due to its curvature and the resulting container pressure from following containers, are transferred into the distribution region by then being transported in the opposite direction.

The guide element can, for example, also be configured as a curved or also non-curved baffle, but angled towards the outlet, against which the containers run during their transport in the buffer region and are conveyed in the direction of the outlet due to the resulting container pressure or the resulting constraint forces. This makes it easy to transfer the containers into the respective regions.

It may be provided that the outlet, viewed in the third direction, is arranged in a region to the left or right of the buffer region. This embodiment is particularly preferred if the containers, when passing through the buffer region, also pass through it on the left or right in the outermost buffer track. This makes it possible to reduce the distance that the containers have to travel in the buffer region. Alternatively, it can also be provided that the outlet is located in a region approximately in the middle of the buffer region, viewed in the third direction. “Approximately in the middle” is to be understood here as the region of the buffer region that extends, viewed in the third direction, from 0.25 times to 0.75 times, preferably from 0.4 times to 0.6 times, the length of the buffer region.

According to the invention, a method for transporting and needs-based buffering of containers is also provided, using a device for transporting and needs-based buffering of containers. The device includes an inlet in which containers can be transported along a first direction, a distribution region comprising at least two transport belts movable independently of each other in a second direction opposite to the first direction, wherein the containers can be fed from the inlet to the distribution region, a buffer region to which containers can be fed from the distribution region, wherein the containers in the buffer region can be conveyed and buffered independently of each other in a third direction transverse to the second direction in at least two buffer tracks, an outlet to which containers can be fed from the buffer region and in which containers can be conveyed along a fourth direction parallel to the third direction, wherein the device comprises a control unit configured to control the at least two transport belts and the at least two buffer tracks. The method comprises controlling the at least two transport belts and the at least two buffer tracks using the control unit such that containers are fed, according to an order in the inlet, to the outlet in substantially the same order after passing through the buffer region.

This method allows for flexible transport and buffering of containers, while simultaneously reducing space requirements.

It may be provided that the control unit controls the at least two transport belts and/or the at least two buffer tracks depending on a required buffer capacity. This embodiment allows for flexible responses to changing operating parameters, in particular during the transport of containers, upstream and downstream of the device.

It can be provided that the device comprises a detector for detecting a container throughput at the inlet and/or outlet, and that the control unit determines a necessary buffer capacity based on the detected container throughput, and/or that the control unit determines the necessary buffer capacity based on at least one operating parameter that is indicative of a container inflow and/or container outflow from the device. This embodiment allows the necessary buffer capacity to be adjusted to the inflow and outflow of containers.

In one embodiment, it is provided that controlling the at least two transport belts and/or the at least two buffer tracks includes controlling a transport speed and/or controlling an acceleration of containers in the at least two transport belts and/or the at least two buffer tracks. This allows for flexible setting of the transport of the containers in the transport belts and buffer tracks, ensuring reliable setting of the buffer capacity.

The inlet and/or outlet may include a multi-row container conveyor. This embodiment allows for the feeding or removal of containers from or into several container treatment machines.

The device may comprise a deflection element that diverts containers from the inlet into the distribution region, and/or the device may comprise a guide element that tapers the buffer region towards the outlet and guides containers in the buffer region towards the outlet.

This embodiment allows for the simple distribution of the containers and targeted redirection of the container flows.

The outlet can be arranged in a region to the left or right of the buffer region when viewed in the third direction. With this embodiment, the distance traveled by containers, in particular in the case where the containers are merely passed through the buffer region, can be reduced, thus making the transport of the containers more efficient.

### BRIEF DESCRIPTION OF THE FIGURES

FIG. 1 shows an embodiment of a device for transporting and needs-based buffering of containers.

FIG. 2 is a flowchart of a method for transporting and needs-based buffering of containers, according to an embodiment.

### DETAILED DESCRIPTION

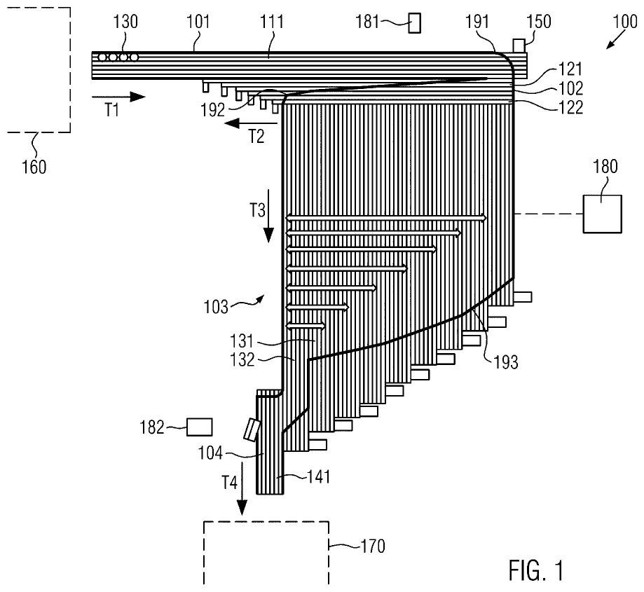

FIG. 1 is a schematic view of a device 100 according to an embodiment The device 100 is provided for transporting containers 130 such as bottles, cans or the like in the beverage processing industry or the cosmetics industry or medical technology. The invention is not limited with regard to the configuration of the containers.

The device 100 can in particular be arranged between two container treatment machines 160 and 170. The container treatment machines 160 and 170 are not restricted in their configuration. For example, the container treatment machine 160 can be a filler or a closure unit that fills and/or closes containers with a product. A combined filler and closure unit, which performs the filling and closing in one machine, may also be provided. The container treatment machine 170 can, for example, be a decoration apparatus or an inspection device and, as a decoration apparatus, can be configured, for example, as a labeling machine or printing machine that can apply one or more decorative elements such as labels or printed motifs to the containers. However, the invention is not limited in this respect and other embodiments of the container treatment machines 160 and 170 are also conceivable.

The device 100 includes an inlet 101, through which containers can be conveyed. The inlet 101 can, for example, be configured as a mass conveyor for the essentially unordered transport of containers 130, but can optionally also include several transport belts 111, which can optionally be separated from each other at least in a partial region of the inlet 101 by guides or limitations such as baffles, so that an ordered transport of the containers in the individual transport belts or lanes formed by these and the limiting elements can take place, at least up to the adjoining distribution region 102.

The containers are transported in the inlet 101 along a first direction T1. In the view shown here, the direction T1 runs from left to right. The inlet 101 can be driven by a drive element 150 such as a servomotor or several servomotors.

The device 100 further comprises a distribution region 102. The containers can be fed to this from the inlet 101. For this purpose, it may optionally be provided that a deflection element 191 is arranged at the end of the inlet 101, which element may, for example, be configured in the form of a curved guide. The containers run in the inlet 101 against this curved guide, and are forced along the deflection element 191 by the movement of the transport belt(s) of the inlet away beneath them, said deflection element, due to its curvature, causing the containers to be transferred into the distribution region 102.

The distribution region 102 comprises at least two transport belts 121 and 122 that are driven independently of one another. These are arranged in such a way that they can convey containers in a second direction T2 counter to the first direction T1. The transport belts 121 and 122 can each include their own drive element or be connected to their own drive element, so that a transport speed and/or acceleration and/or deceleration of containers in the respective transport belts is possible independently of the other transport belt in each case. The distribution region is not limited with regard to the number of transport belts provided, and therefore more than the at least two transport belts, for example three or four or five transport belts or more, can also be provided. These are then each designed in such a way that they can be driven independently of one another.

Furthermore, the device 100 comprises a buffer region 103. The buffer region comprises two buffer tracks 131 and 132. The buffer tracks are designed in such a way that they allow the containers to be transported independently of one another. Each buffer track can, for example, comprise a transport belt that can be moved in a third direction T3, transverse to the second direction T2, via a drive element such as a servo drive, in order to transport the containers from the distribution region towards an outlet 104.

However, it may also be provided that the buffer region 103 comprises more than one transport belt in each of the buffer tracks 131, 132.

According to the invention, the buffer tracks are in each case to be understood in such a way that, regardless of the number of transport belts per buffer track, the containers in each buffer track (i.e. optionally in each transport belt of a respective buffer track) are transported at exactly one transport speed, wherein the transport speed of the containers in the individual buffer tracks may be different.

In order to enable the transfer of the containers from the distribution region 102 to the buffer region 103, a further deflection element or guide element 192 can be provided, which, due to its curvature, causes containers running against this deflection element 192 in the distribution region to be deflected in the direction of the buffer region 103. It may advantageously be provided that the guide element is mechanically adjustable with regard to its position and/or its shape. The guide element 192 can, for example, be configured as a sheet metal part and be mounted on a guide that allows a translational movement of the entire guide element. A drive element, such as a servomotor, can be provided for moving the guide element 192 along the guide. Alternatively or additionally, one or more regions of the guide element 192 can be movable relative to one another. For this purpose, each region can be rigidly connected to an actuator, for example an actuating drive. The contour of the guide element 192 can be changed by actuating at least one of the actuators (e.g. automatically). In this embodiment, the guide element can be configured in one piece (for example as a sheet metal part) or in multiple pieces, wherein the elements forming the guide element 192 can be movable relative to one another, and each element is preferably connected to exactly one separate actuator in order to change the contour of the guide element 192.

This distributes the containers within the buffer region 103.

Viewed in the direction T3, according to the invention an outlet 104 is provided opposite the distribution region, to which outlet the containers can be fed from the buffer region 103. In this case, it may in particular be provided that the outlet 104, viewed in the third direction T3, is located on the left or right or approximately in the middle of the buffer region or at least of one buffer track, such that the containers from this buffer track can be fed to the outlet 104. In order to also enable the transfer of containers from other buffer tracks, a further guide element 193 can be arranged in the buffer region 103, which guide element is curved in such a way that the containers running against this guide element 193 are deflected in the direction of the outlet 104.

In this case, it may be provided that, in a plan view of the device, the outlet 104 is located to the left of the buffer region 103 when the direction T1 runs from left to right, the direction T2 from right to left and the direction T3 from top to bottom, as in the embodiment shown in FIG. 1. This ensures that, in a case where buffering of containers in the buffer region 103 is not necessary, the containers can be fed directly to the outlet 104 via the first buffer track 132 without buffering. In this case, the buffer region 103 serves only as a transport device that can bridge the distance between the distribution region and the outlet 104.

If the directions extend opposingly, i.e. the first direction T1 from right to left, the second direction T2 from left to right and the third direction T3 again from top to bottom, then the outlet 104 can be arranged on the right-hand side of the buffer region in the embodiment shown in FIG. 1. In other words, in one embodiment it can be provided that the outlet 104 is always arranged on the side of the buffer region from which containers are fed into the inlet 101.

In principle, it can be provided that the inlet and the outlet are arranged either on the same side of the buffer region or on opposite sides of the buffer region.

According to the invention, the device 100 further comprises a control unit 180, which is configured such that it can control the transport belts 121 and 122 in the distribution region and the buffer tracks 131 and 132 in the buffer region 103 in such a way that containers which arrive at the inlet 101 in a certain order (i.e. a numbered sequence of containers) reach the outlet in substantially the same order.

In this case, the control of the transport speeds and/or the acceleration and/or deceleration of the containers in the individual transport belts or buffer tracks can be carried out in particular on the basis of container flow rates measured with detectors 181, 182 (such as a camera or a light barrier) in the inlet and outlet or upstream of the inlet and downstream of the outlet. Alternatively or additionally, the control can also take place based on operating parameters made accessible to the control unit in other ways, in particular the throughput of container treatment machines 160 and 170. If, for example, a difference is identified between the container throughput in container treatment machine 160 and the container throughput in container treatment machine 170, a buffer capacity in the buffer region can be achieved, based on the size of this difference, by setting the transport speeds in the individual buffer tracks 131 and 132.

In this case, the control unit can, for example, have a deterministic algorithm, by means of which it is possible to determine the necessary settings for the transport speeds in the transport belts and/or the buffer tracks for achieving a specific buffer capacity. For this purpose, the control unit can, for example, include a memory, particularly in the form of a lookup table, in which specific sets of transport speeds in the individual transport belts and buffer tracks are assigned to specific container throughputs upstream and downstream of the device. Depending on the measured or transmitted throughputs, the stored combination of speeds can then be selected and set by the control unit.

Alternatively, the control unit can also comprise a trained neural network, which is generally known from the prior art, in particular from WO 2024/008342 A1. This neural network may have been trained using a plurality of different combinations of container throughputs upstream and downstream of the device, such that it can determine the most suitable combinations of speeds for the individual transport belts and buffer tracks. This embodiment enables the most flexible and seamless adaptation possible to any combination of throughputs of containers downstream and upstream of the device.

The training of the neural network can be carried out in particular as described below.

First, a digital twin model of the device, in particular of all the transport and buffer belts, can be created using simulation software (game physics engine). Subsequently, several simulations of the operation of the device can be carried out using a suitable DOE (Design of Experiment) or sequentially, wherein each simulation is preferably performed at different belt speeds. In this case, the occupancy rate in predefined regions is determined in the simulation, in order to estimate the uniformity of the bottle distribution at the beginning of the inlet. After collecting these data, an environmental model is created to investigate other (unseen) scenarios/belt speeds and their influence on the bottle distributions.

Subsequently, for example, a camera or another sensor can be used to measure the actual occupancy rate at different belt speeds, and various simulations can be carried out again thereby, in order to thus obtain one or more real data sets. The trained environmental model is further optimized with regard to its parameters using these real data sets. An AI model is trained to minimize the variation between different regions and maximize the uniformity of the bottle distribution. If access to the machine is not available in reality, the trained model (game engine data) can be checked and/or optimized on the physics engine. In this case, for optimization and training, a generally known award model can be used, which assigns an award in the case of correct determination of the belt speeds for a specific occupancy, so that the parameters of the AI model (neural network) are optimized towards a correct determination of the belt speeds and incorrect determinations of the belt speeds are reduced with progressive training.

The actual training phase can optionally be carried out through direct interaction with the optimized model, wherein an agent interacts with the environment in each defined time step by manipulating the speeds of the transport belts. This continuous interaction is carried out either at least for a certain period of time during the transport of a mass flow of containers, or from the beginning to the end of the mass flow of containers. By using camera/sensor measurements of the occupancy rate, which measurements represent the distribution of the mass flow, the distribution of the mass flow can be included as an evaluation function for the agent, which provides a value for assessing the series/combination of belt speeds along several defined time steps. The agent's goal is to achieve an optimal assessment value and thus a uniform distribution of the mass flow.

A plurality of options can be used to measure the occupancy rate.

For example, a camera and associated image processing software can be used, which specifically assigns pixels, in the images captured by the camera, to containers. By identifying and labeling pixels belonging to a container, the number of container pixels in a specific predefined region is determined and then subtracted from the total number of pixels present in that region. This is how the occupancy rate can be determined. A segmented model can then be used, which is trained with labeled data (pixels and associated information on whether it is a container pixel or not) and a defined class. Alternatively, a training-free model can also be used. This type of AI model searches for pixels that belong to a specific label (for example using similarity analyses) and recognizes them in the defined region.

Alternatively or additionally, an ultrasonic sensor can also be used to determine the occupancy rate. The ultrasonic sensor is placed above the inlet, for example, and aligned so that it can send waves in the direction of the belt and detect reflections from the containers. The sensor emits, for example, ultrasonic waves with one or more specific frequencies. These waves travel through the air and bounce back when they hit an object. The sensor detects the reflected waves. The time it takes for the waves to return is measured. Based on the time of flight (the time the waves need for the round trip), the sensor calculates the distance between itself and the object. If the measured distance is smaller than the distance to the empty belt, this indicates the presence of an object. By continuously measuring the distance at different points along the belt, the sensor can determine the occupancy rate. By integrating data about time and about the width of the belt, the overall occupancy rate can thus be calculated, i.e. how much of the belt is occupied by containers. These data can then be used for training and/or in operation.

Alternatively or additionally, one or more light barriers can be used to determine the occupancy rate. These light barriers can use a light beam (visible or infrared) to detect the presence or absence of objects. The light barriers detect the presence of an object if the light beam emitted by the respective light barrier is interrupted (in the case of transmission and retroreflection types) or if the light is reflected back (in the case of diffuse reflection types). Several light barriers can be used, in order to cover different portions of the belts (for example at the inlet) and to provide data about the presence of containers along the length of the belt.

While the above description in principle assumed that a model was created and/or trained based on a container size and/or container shape, it may be provided that for each container size and/or container shape, a model is first created and/or trained for determining the belt speeds, for example for achieving a certain occupancy rate. These models can then be combined in order to thus obtain a closed model for each container size and/or container shape, which can then be used in operation. The model can then determine the container size and/or container shape during operation, for example based on measurements during operation, or said size and/or shape can be specified to the model during commissioning and/or type changeover of the containers. Based on this information and based on values relating to occupancy rates, measured during operation, the belt speeds can then be optimized.

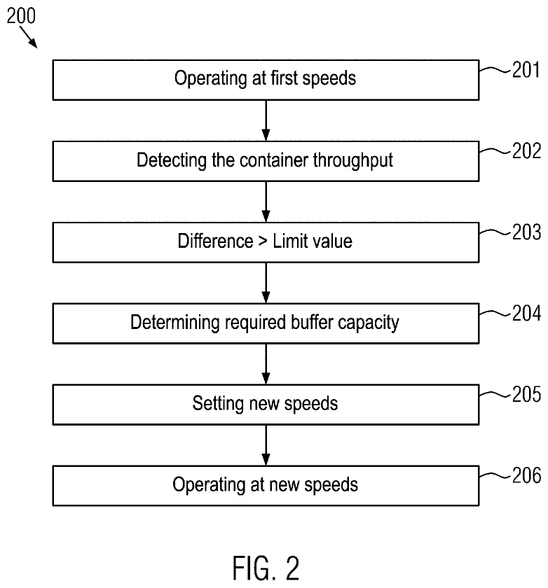

FIG. 2 shows a possible embodiment of a method for transporting and needs-based buffering of containers, which can be carried out with the device according to the embodiments of FIG. 1.

The method 200 begins initially with step 201, in which the device is operated at predetermined speeds for the individual transport belts and buffer belts. This can be a state in which no buffering of containers in the buffer region is necessary, but rather the containers are simply passed through the buffer region, as has already been described above. However, this could also be a state where the containers are already partially buffered in the buffer region, in order to compensate for a difference in container throughput between the inlet and the outlet.

With the detectors 181 and 182 described in connection with FIG. 1, the container throughputs can be detected in step 202 at the inlet or outlet or upstream of the inlet and downstream of the outlet. Alternatively, as already described, the detection can also be carried out by appropriate transfer of parameters characterizing the throughput during operation of container processing machines arranged downstream or upstream, such as the container processing machines 160 and 170.

The control unit can then compare the container throughputs in step 203. In this case, it can be checked in particular whether a difference in the container throughputs exceeds a certain limit value. This limit value can be determined, for example, depending on the current difference in container throughputs, and can be specified, for example, as a relative value of the larger or smaller container throughput. Differences below the amount of this limit value, i.e. both positive and negative, can be disregarded, as the necessary changes in the transport speeds would be too small, for example. As an alternative to determining whether the difference in the container throughputs is greater or less than a limit value, any obtained difference in the container throughputs that deviates from a current difference can also be used to control the transport speeds of the transport belts and/or buffer tracks.

In step 204, the necessary buffer capacity is then determined from the difference. This may in particular include determining the number of containers that need to be stored in the buffer region per unit of time, from the difference in the container throughputs. If the difference in throughput is, for example, 500 containers/min, meaning that 500 fewer containers can pass through the outlet than are fed into the device via the inlet, then 500 containers/min must be temporarily stored in the buffer region and cannot be transported onwards directly to the outlet. If the difference is negative, i.e. if more containers flow out through the outlet than flow in through the inlet, the buffer capacity becomes negative, or the number of containers buffered in the buffer region must be reduced, and specifically according to the difference in flow rates. Assuming again that the difference in this case is −500 containers/min, i.e. 500 more containers flow out via the outlet than flow in via the inlet, then an additional 500 containers per minute must be transferred from the buffer region to the outlet.

Once the necessary buffer capacity has been determined, in step 205 the combination of speeds of the transport belts and buffer tracks can first be determined and then set. Once these are set, in step 206 the device can then be operated with the new speeds for the transport belts and buffer tracks, so that the operation of the device can be carried out with the newly set speeds.

In this case, the determination of the speeds is always carried out in such a way that the order of the containers in the outlet substantially corresponds to the order of the containers in the inlet.

In principle, in order to increase the buffer capacity, the transport speed in the buffer track closest to the outlet is reduced. As a result, fewer containers then flow directly from the distribution region to the outlet, but instead push into buffer tracks adjacent to the first buffer track. Depending on the reduction in the speed of the buffer track closest to the outlet, the containers are distributed over at least one further, but optionally also several further, buffer tracks, such that the buffer capacity of the buffer region increases further. By appropriately setting the transport speeds in the distribution region and the transport speeds in the buffer region, and optionally by targeted structuring of the deflection elements and the guide elements, it can then be achieved that the containers essentially maintain their order upon reaching the outlet, compared to the order in the inlet.

This does not necessarily presuppose that the order in the buffer region is the same, as the containers can be distributed in different buffer tracks.

We claim:

1. A device for transporting and needs-based buffering of containers, the device comprising:
an inlet in which containers can be transported along a first direction;
a distribution region comprising at least two transport belts movable independently of each other in a second direction opposite to the first direction, wherein the containers can be fed from the inlet to the distribution region;
a buffer region to which containers can be fed from the distribution region, wherein the containers in the buffer region can be conveyed and buffered independently of each other in a third direction transverse to the second direction in at least two buffer tracks; and
an outlet to which containers can be fed from the buffer region and in which containers can be conveyed along a fourth direction parallel to the third direction;
wherein the device comprises a control unit configured to control the at least two transport belts and the at least two buffer tracks such that containers are fed, according to an order in the inlet, to the outlet in substantially the same order after passing through the buffer region.

2. The device according to claim 1, wherein the control unit is configured to control the at least two transport belts and/or the at least two buffer tracks depending on a required buffer capacity.

3. The device according to claim 2, wherein the device comprises a detector for detecting a container throughput at the inlet and/or outlet, and wherein the control unit is configured to determine a necessary buffer capacity based on the detected container throughput.

4. The device according to claim 2, wherein the control unit is configured to determine the necessary buffer capacity based on at least one operating parameter that is indicative of a container inflow and/or container outflow from the device.

5. The device according to claim 1, wherein controlling the at least two transport belts and/or the at least two buffer tracks comprises controlling a transport speed and/or controlling an acceleration of containers in the at least two transport belts and/or the at least two buffer tracks.

6. The device according to claim 1, wherein the inlet and/or outlet comprise a multi-row container conveyor.

7. The device according to claim 1, wherein the device comprises a deflection element for deflecting containers from the inlet into the distribution region, and/or wherein the device comprises a guide element that tapers the buffer region towards the outlet and can guide containers in the buffer region towards the outlet.

8. The device according to claim 1, wherein the outlet, viewed in the third direction, is arranged in a region to the left or right of the buffer region.

9. A method for transporting and needs-based buffering of containers, using a device for transporting and needs-based buffering of containers, the device including
an inlet in which containers can be transported along a first direction,
a distribution region comprising at least two transport belts movable independently of each other in a second direction opposite to the first direction, wherein the containers can be fed from the inlet to the distribution region,
a buffer region to which containers can be fed from the distribution region, wherein the containers in the buffer region can be conveyed and buffered independently of each other in a third direction transverse to the second direction in at least two buffer tracks, and
an outlet to which containers can be fed from the buffer region and in which containers can be conveyed along a fourth direction parallel to the third direction, wherein the device comprises a control unit configured to control the at least two transport belts and the at least two buffer tracks,
the method comprising:
controlling the at least two transport belts and the at least two buffer tracks using the control unit such that containers are fed, according to an order in the inlet, to the outlet in substantially the same order after passing through the buffer region.

10. The method according to claim 9, wherein the control unit controls the at least two transport belts and/or the at least two buffer tracks depending on a required buffer capacity.

11. The method according to claim 10, wherein the device comprises a detector for detecting a container throughput at the inlet and/or at the outlet, and wherein the control unit determines a necessary buffer capacity based on the detected container throughput, and/or wherein the control unit determines the necessary buffer capacity based on at least one operating parameter that is indicative of a container inflow and/or container outflow from the device.

12. The method according to claim 9, wherein controlling the at least two transport belts and/or the at least two buffer tracks comprises controlling a transport speed and/or controlling an acceleration of containers in the at least two transport belts and/or the at least two buffer tracks.

13. The method according to claim 9, wherein the inlet and/or outlet comprises a multi-row container conveyor.

14. The method according to claim 9, wherein the device comprises a deflection element that deflects containers from the inlet into the distribution region, and/or wherein the device comprises a guide element that tapers the buffer region towards the outlet and guides containers in the buffer region towards the outlet.

15. The method according to claim 9, wherein the outlet, viewed in the third direction, is arranged in a region to the left or right of the buffer region.
